(19) United States
(12) Patent Application Publication
(10) Pub. No.: US 2008/0040329 A1
(43) Pub. Date: Feb. 14, 2008

(54) System and Method for Influencing a Computer Generated Search Result List

(76) Inventors: John Cussen, Victoria (AU); Toni Henson, Victoria (AU); Mark Armstrong, Victoria (AU); Elisabet Wreme, Victoria (AU)

Correspondence Address: KENYON & KENYON LLP, 1500 K STREET N.W., SUITE 700, WASHINGTON, DC, 20005, US

(21) Appl. No.: 11/629,679

(22) PCT Filed: Jul. 5, 2005
(86) PCT No.: PCT/AU05/00977

§ 371 Date: Aug. 16, 2007

(30) Foreign Application Priority Data
Jul. 8, 2004 (AU) 2004903764

(51) Int. Cl. G06F 17/30

(52) U.S. Cl. 707/3; 707/E17.001

(57) ABSTRACT

A method of generating a search result list in response to a search request from a searcher, comprising: (a) maintaining a database of search listings each associated with an advertiser, wherein each search listing is associated with; (i) a network location or other contact information; (ii) at least one search term; and (iii) an advertiser bid amount that is modifiable according to a comparison between a geographical location specified by a searcher and geographical location attributes specified by the advertiser; (b) receiving a search request from the searcher; (c) identifying the search listings having search terms generating a match with the search request; (d) ordering the identified search listings into a search result list in accordance with an algorithm applied to each search listing which algorithm includes a location variable component having a value that depends upon the geographical location attributes specified by the advertiser compared to a location specified by the searcher; (e) receiving a request from the searcher to retrieve information associated with a search listing in the search result list generated at step (d); and (f) recording the retrieval request event including account identification information corresponding to the advertiser and calculating an advertiser charge amount based upon the advertiser bid amount, to permit maintenance of accurate advertiser account records.

This is a 371 national phase application of PCT/AU2005/000977 filed 5 Jul. 2005, which claims priority to Australian patent application No. 2004 903764 filed 8 Jul. 2004, the contents of which are incorporated herein by reference.

### FIELD OF THE INVENTION

The present invention relates to a system and method for influencing the order of results in a search results list generated in response to a query on a computer network. In particular it relates to a method of influencing the order of results in a pay-per-performance search system in accordance with criteria associated with geographical location attributes.

### BACKGROUND OF THE INVENTION

In this specification where a document, act or item of knowledge is referred to or discussed, this reference or discussion is not an admission that the document, act or item of knowledge or any combination thereof was at the priority date publicly available, known to the public, part of the common general knowledge or known to be relevant to an attempt to solve any problem with which this specification is concerned.

While the present invention will mainly be described with reference to wired applications such as the home PC it will be appreciated that the invention is not so limited but can be applied to other applications including wireless applications including voice operated systems.

The expansion of Internet usage and access to the World Wide Web has created a unique marketplace. In its simplest sense the Web is a database which provides Internet users with access to a vast and ever increasing collection of documents covering myriad subject matter.

Because of its inherent characteristics of fast distribution of information across multiple markets, the Internet is a particularly attractive medium for advertisers to promote their products and services. An advertising presence on the Web has the potential to introduce consumers in any part of the globe to the commercial activities of businesses and individuals operating locally or in other jurisdictions.

Due to the fact that the Web stores a vast number of documents on millions of web pages dispersed across computer systems all over the world, directories and search engines have been developed to search the Web to locate information of interest and organize the search results into a logical format that Internet users will understand. For example, Internet users can input a query (usually search terms which include key words) to a search engine which will return to them with a list of web pages corresponding to their query which can be accessed through a hyperlink.

Clearly, it can be an advantage to advertisers to be able to influence the results returned by search engines. The more times an advertiser appears in search listings, or the greater their prominence in a search listing, the better their exposure to consumers. It is particularly advantageous if the goods or services of the advertiser can be targeted appropriately to consumer interests. For example, consumer interests are often reflected by the queries they enter into search engines in the form of keywords or topical search requests.

However, prior search engines and web site directories have processes and algorithms that often generate irrelevant search results, selecting and ranking web pages based on very mathematical criteria that are easily influenced remotely by astute marketers. The number of irrelevant results is often increased by the excessive and cynical use of intersite hyperlinks between web sites. This excessive use of hyperlinking is readily picked up by automated search technology and used in link popularity based search ranking algorithms. In order to attract consumer attention by having their web sites appearing on as many search lists as possible, web site designers often include hyperlinks that are not directly relevant to the site content. This is a relatively simple, low cost tactic by advertisers to increase their profile but creates advertising that is irrelevant and often annoying to consumers. Many search engines are not capable of prioritizing results in accordance with consumers' preferences.

Many search engines operate on a system whereby advertisers pay for each click-through referral generated by a search result list. In one form, advertisers make monetary ‘bids’ to secure priority on a search results list for certain keywords. The higher the bid compared with other advertisers, the higher the position on a search results list and the greater the likelihood a consumer will be referred to the advertiser's web site through the search result list. In these systems, advertisers need to carefully select and bid on search keywords that are relevant to their web site offerings, otherwise they will pay for click-through by customers having no genuine interest in their goods or services. However selection of a keyword is not the only criteria for relevancy of a web page or the goods or services it advertises and consumers still receive irrelevant search results.

Accordingly, there is a need for advertisers to be able to more effectively target their advertising in the form of Web pages to appropriate groups of consumers. Also to more effectively avoid advertising to consumers who have no interest in the goods or services offered by the advertiser.

### SUMMARY OF THE INVENTION

The present invention provides a system and method for enabling an advertiser to influence when and how a search result listing for goods or services is presented to potential customers in response to their queries.

In particular, the present invention provides a method of generating a search result list in response to a search request from a searcher, comprising:
(a) maintaining a database of search listings each associated with an advertiser, wherein each search listing is associated with,
   (i) a network location or other contact information;
   (ii) at least one search term; and
   (iii) an advertiser bid amount that is modifiable according to a comparison between a geographical location specified by a searcher and geographical location attributes specified by the advertiser;
(b) receiving a search request from the searcher;
(c) identifying the search listings having search terms generating a match with the search request;
(d) ordering the identified search listings into a search result list in accordance with an algorithm applied to each search listing which algorithm includes a location variable component having a value that depends upon the geographical location attributes specified by the advertiser compared to a location specified by the searcher;
(e) receiving a request from the searcher to retrieve information associated with a search listing in the search result list generated at step (d); and
(f) recording the retrieval request event including account identification information corresponding to the advertiser and calculating an advertiser charge amount based upon the advertiser bid amount, to permit maintenance of accurate advertiser account records.

The advertiser bid amount may be a single value or a range of values. Typically the calculated advertiser charge amount cannot exceed the single value or the upper limit of a range. The charge amount is calculated at the time a consumer makes a query and is equal to the minimum money amount required for the advertiser to retain the most favorable rank possible within the set of matching advertiser listings.

Preferably, the algorithm has a variable popularity component indicative of the past popularity of the network location or other contact information to searchers. Typically, this may be evaluated by the click through rate of such location or information.

Advertiser

The advertiser may be, for example, a business promoter, advertising campaign manager, web site promoter or any other individual involved in seeking sales for a business or individual endeavor. An advertiser may be a ‘full service’ advertiser, that is, one represented by dedicated campaign managers responsible for keyword expansion and selection, editorial assistance, budget management and other aspects of campaign management.

Alternatively the advertiser may have self-service access so they can register, set up and manage their own campaigns online through full access to their account. This may include for example, giving advertisers the ability to devise and activate their own campaigns and to monitor all aspects of a campaign, such as start and end dates, financial limits and generation of reminders when financial limits are met. Typically an intending self-service advertiser can initiate set up of their account via a ‘wizard’ accessible through the user interface.

Keyword

The advertiser may identify, target and bid for the keywords that are relevant to their listing. Preferably the consumer can access a keyword tool that provides a list of suggested keywords, and variations on these keywords (such as plurals, synonyms, extensions) in response to the advertiser entering a ‘seed’ keyword. Preferably the consumer can also be provided with an estimate of the number of clicks a chosen keyword will deliver, the likely ranking it will deliver and the cost of targeting the keyword.

Search queries may be initiated implicitly or explicitly, for example via Internet advertising servers, telephone directory assistance and concierge systems, mobile device internet and messaging systems, and in-car navigation systems. In particular, the present invention includes systems and methods that enable an advertiser to request a listing for a specific advertisement delivery type (voice, internet, wireless or location device), select descriptors for their goods or services such as keywords and/or business category and/or locations serviced by the advertiser and to specify the locations serviced by the advertiser. Depending on the type of medium involved the search listing will be associated with a network location or other contact information such as a telephone number, street address or e-mail address.

Searching

Typically the searcher is a consumer seeking goods or services. When a consumer enters a search term (keyword) in a search engine, preferably an expanded exact match search is carried to locate listings associated with keywords that ‘nearly’ match. With this type of matching the system automatically locates highly relevant keywords and variations including plurals and other stems, abbreviations, acronyms and initialisms, common misspellings, synonyms and related phrases. Matching occurs on these variations even if they are not explicit in the advertiser's keyword rule. It will be readily apparent to the person skilled in the relevant technology that other types of keyword searching could be utilised in the present invention. These listings are then put in a results list and displayed to the consumer.

Typically the display includes one or more listings. For example, the display may include a core results list that takes prominence on the page, and one or more additional results lists occurring as 'sidebars' at the top, bottom or side of a display or as an advertisement within content pages. Advertisers can nominate the placement type, that is, whether they would prefer their listing to appear in the main results list and/or the sidebars.

Typically premium listings appear at the top of the core results list. If more advertisers are targeting a keyword than there are placements on the first display page, additional listings will be shown on subsequent results pages. Sidebar result lists have the same targeting attributes as the premium listings but consumers are less inclined to look at sidebar results as compared with premium listings.

Pay-for-Performance

The frequency and order of an advertiser's listing being displayed in the search list generated by the invention is influenced by interactive participation in a competitive bidding process colloquially known as a “pay-for-performance” process. Advertisers can bid against other advertisers for their listings to be given priority in ranking against targeted keywords.

Typically, an advertiser accesses their account through a secure web site in order to place their bids. A bid corresponds to the maximum money amount that the advertiser will pay to the owner of the pay-for-performance system each time a consumer clicks on the advertiser's hyperlinked listing. Each time an advertiser's listing is clicked on the system may optimise the amount payable by the advertiser down to the lowest price necessary for the best possible ranking position.

The listing may be linked to a website URL or alternatively, the listing may be linked to a phone number/toll free number. Typically the system will set a default floor price, and a default amount by which bids can rise. In addition there may be tiered floor prices for listings associated with high-demand or high-frequency keywords.

Typically, the consumer can access a map or directions to a location where they can obtain supply of the advertiser's goods or services. They may also receive other advertising features such as an SMS detailing the advertiser's business activities. The method of the present invention may be used in a wired or wireless media such as a web site, Internet search engine, phone directory assistance system, mobile device Internet and messaging systems, or in-car navigation systems.

Typically, when a consumer clicks on an advertiser listing, the system matches the searcher with an appropriate advertising display in their local language. For example, this ensures that a searcher say, in the UK, receives an advertisement in the English language, while a searcher in France receives an advertisement in the French language.

Location and Ranking

The algorithm applied to each search listing includes a location variable component having a value that depends upon the geographical location attributes specified by the advertiser compared to a location specified by the searcher. The result generated by the algorithm is a “potential yield” which can determine the order in any associated search results list. The potential yield may also be influenced by other factors such as the advertiser's historic measured relevancy.

In the invention a listing is associated with location attributes. Location is a very broad term and can apply to both very large and very small geographical areas. Advertisers will typically have the option of an international, national, regional or local campaign. Typically, the advertiser will be required to select either (i) a collection of locations (e.g. all Australia, all Melbourne, all locations in central Victoria or a particular suburb and all adjoining suburbs), (ii) a specific location (e.g. Melbourne, Collingwood, or central Victoria) or (iii) no locations.

Locations will also be subject to validation. For example, advertisers may be prevented from certain selections such as “national” in addition to locations within the nation because the latter would be redundant. If conflicts are detected, such as misspelling of a location name, or a location exists in multiple states appropriate prompts for clarification may be generated.

Accordingly when a consumer carries out a search and requests information related to the advertiser's goods or services (either geographically, topically or specifically) the system will determine which advertisers will be presented to the searcher in a search list, the order being influenced by parameters defined by the advertiser.

Thus, in contrast to two basic systems of the prior art in which either the system operator totally controlled rankings in a search list, or the advertiser controlled ranking by just bidding more than the then highest bid, the current system allows a hybrid of these activities. Namely, the use of location as a variable (which can be set by the system operator) and the bid amount (which is set by the advertiser) means that the algorithmic outcome (namely the order) may influenced by both parties. Experience has shown that more location specific search listings are accessed more often by customers. As such, using a location related parameter in the ranking algorithm serves both the system operator and advertiser. Advertisers are more likely to attract sales and the system operator is optimizing its revenue by biasing the rankings in favor of such listings.

Advertiser Account

The present invention can be facilitated using a computer system comprising a database having at least one account record for each of a plurality of advertisers, the account record including:
(a) at least one search listing including:
   (i) a network location or other contact information;
   (ii) at least one search term; and
   (iii) an advertiser bid amount that is modifiable according to a comparison between a geographical location specified by a searcher and geographical location attributes specified by the advertiser;
(b) an account balance;
(c) a history of search listings;
(d) payment processing information, wherein said payment processing information is accessible to the computer system and isolated from public access via the computer network; and
(e) a payment history.

In use, typically the advertiser (in person, or through their campaign manager) sets up their organisation and account details, payment arrangement, initial campaign and listing. They can then select a search term comprising one or more keywords or a category that describes the goods or services to be promoted. The advertiser then nominates a bid amount for their listing.

The ranking process occurs when the advertiser's listing matches a search query instigated by a consumer. At that time, the potential yield of the advertiser's listing is calculated using the algorithm and compared to potential yields of other listings that match the keyword, category or location attributes of the consumer's query. A number of advertiser listings with the highest potential yield are selected by the service for presentation to the consumer. Typically the advertiser's bid amount is not processed at bid time. An indicative rank may be displayed to advertisers in the online system but this rank does not account for the location affect of the matching system. As such, typically new bids are not processed in real time and the amount paid per referral is calculated once the list of appropriate advertisers has been selected.

Account Updating

Search listing information may also need to be updated from time to time by the advertiser in accordance with changes to their business or to take account of new advertising campaigns. Accordingly, the present invention also provides for updating of information relating to a search listing on a search result list generated by a computer network search engine in response to a search request received from a remote computer over the computer network, comprising the steps of:
(A) maintaining an account database having at least one account record for each of a plurality of advertisers, the account record including:
   (a) at least one search listing including;
      (i) a network location or other contact information;
      (ii) at least one search term; and
      (iii) an advertiser bid amount that is modifiable according to a comparison between a geographical location specified by a searcher and geographical location attributes specified by the advertiser;
   (b) an account balance;
   (c) a history of search listings;
   (d) payment processing information, wherein said payment processing information is accessible to the computer system and isolated from public access via the computer network; and
   (e) a payment history;
(B) receiving from an advertiser a change request for a search listing in the advertiser account record;
(C) updating the search listing in the advertiser account record in response to the change request; and
(D) determining a position for the updated search listing in a search result list generated by the search engine in response to a search request received from a searcher using the computer network;
(E) calculating the position of the updated search listing in the search result list using an algorithm applied to each search listing which algorithm includes a location variable component having a value that depends upon the geographical location attributes specified by the advertiser compared to a location specified by the searcher.

In another embodiment of the present invention, there is provided a method for updating information relating to a search listing on a search result list through a computer network, the method comprising the steps of:
(A) maintaining an account database having at least one account record for each of a plurality of advertisers, the account record including:
   (a) at least one search listing including;
      (i) a network location or other contact information;
      (ii) at least one search term; and
      (iii) an advertiser bid amount that is modifiable according to a comparison between a geographical location specified by a searcher and geographical location attributes specified by the advertiser;
   (b) an account identifier;
   (b1) an account balance;
   (b2) payment processing information for the advertiser, said payment processing information maintained isolated from public access via the computer network;
   (b3) a payment history;
   (b4) a history of search listings; and
   (c) other search listings against which is set the rank of the search listing;
(B) providing the advertiser with authenticated login access, wherein the advertiser's login access permits the advertiser to modify their account record;
(C) modifying a search listing of the account record upon receiving a request from said advertiser and later exporting that listing to a listing index for searching;
(D) receiving a search request, the search request including at least one keyword and a location, the search request being received over the Internet from a searcher at a remote computer; and
(E) generating a search result list comprised of search listings wherein the search term and geographical location attributes for each search are matched to the search request, the search listings in the search result list being ordered in accordance with an algorithm applied to each search listing which algorithm includes a location variable component having a value that depends upon the geographical location attributes specified by the advertiser compared to a location specified by the searcher.

The bid amount is not the only factor affecting the rank. Likewise the keyword is not the only attribute for selection. Consequently, it is preferable to calculate the actual cost per referral once a result has been selected by the consumer. While another advertiser may match for the same search terms and location, it is possible that their listing has different attributes for some or all of those fields. As such, it is not possible to generate rank values for all listings that match against the selected terms.

Rank values are preferably not calculated in real time but are calculated when a consumer makes a query and that is the first time the set of matching advertisers is known to the system. The potential yield of a listing determines the order in which the advertiser's listing will be presented in response to a request made by the consumer. While a higher advertiser bid amount can increase the potential yield of a listing it does not automatically result in a higher rank value or guarantee more advantageous placement over competitors with lower maximum bids. As indicated, the potential yield is also influenced by location. The higher the potential yield the more likely and sooner a listing will be presented to the consumer.

Accordingly the system typically includes account information which can be readily updated by the advertiser. One embodiment of the system and method of the present invention provides a database with at least one account record for each of a plurality of advertisers, the account record including:
(a) at least one search listing including;
   (i) a network location or other contact information;
   (ii) at least one search term; and
   (iii) an advertiser bid amount that is modifiable according to a comparison between a geographical location specified by a searcher and geographical location attributes specified by the advertiser;
(b) an account balance;
(c) a history of search listings;
(d) payment processing information, wherein said payment processing information is accessible to the computer system and isolated from public access via the computer network; and
(e) a payment history.

Typically the present invention provides a method of enabling an advertiser to update information relating to a'search listing on a search result list generated by a computer network search engine, comprising the steps of:
(A) maintaining an account database having at least one account record for each of a plurality of advertisers, the account record including:
   (a) at least one search listing including;
      (i) a network location or other contact information;
      (ii) at least one search term; and
      (iii) an advertiser bid amount that is modifiable according to a comparison between a geographical location specified by a searcher and geographical location attributes specified by the advertiser;
   (b) an account balance;
   (c) a history of search listings;
   (d) payment processing information, wherein said payment processing information is accessible to the computer system and isolated from public access via the computer network; and
   (e) a payment history;
(B) receiving from an advertiser a change request for a search listing in the advertiser account record;
(C) updating the search listing in the advertiser account record in response to the change request; and
(D) determining a position for the updated search listing in a search result list generated by the search engine in response to a search request received from a searcher using the computer network;
(E) calculating the position of the updated search listing in the search result list using an algorithm applied to each search listing which algorithm includes a location variable component having a value that depends upon the geographical location attributes specified by the advertiser compared to a location specified by the searcher.
   Account Management

Each account typically includes contact, billing, credit approval and work order information for an advertiser. In addition, each account may include at least one advertiser listing for voice, wireless, Internet or SMS delivery, each search listing having twelve components: a text description of the business, product or service to be listed, a voice description of the business to be telephoned, the physical address of the business, the Uniform Resource Locator (URL) of a web site, keywords, business categories, a maximum bid amount, locations serviced and a title for the advertiser's listing. Each account may also include the advertiser's payment history and a history of search listings entered by the user. The advertiser may log into their account via an authentication process running on a secure server. Once logged in, the advertiser may add, delete, or modify a search listing. The functions of adding or deleting a search listing, or modifying the bid amount of a search listing does not initiate the competitive bidding. The auction process is initiated by the consumer and the auction participants are selected based on the parameters set by the consumer's request. Advertiser listing changes and modifications are batch processed.

Preferably, the advertiser charge amount calculated for each referral made by the service will be deducted from an advertiser account balance. Typically the advertiser accounts are settled using a system of direct debit from a nominated credit card or bank account. For example the debit transactions may occur periodically, at nominated intervals. Alternatively the advertiser may opt to receive an invoice for settlement at the end of each month. In another embodiment the advertiser may select a ‘top up’ arrangement, whereby their account is kept in credit and when the credit falls below a set value, a nominated monetary amount is transferred from a credit card or bank account to the advertiser account.

Programming Code

In order to implement the method and system of the present invention it will be readily apparent that relevant programming code will be required. The system of the present typically includes, for example,
(A) programming code for providing the advertiser with login access in response to authentication, wherein the advertiser's login access grants the advertiser access to modify the advertiser account record, the advertiser not being provided with access to modify the accounts of others;
(B) programming code for adding money to increase the account balance of an advertiser upon receiving a request from said advertiser;
(C) programming code for adding a search listing to an advertiser account record upon receiving a request from said advertiser and subsequently exporting the search listing to the listing index in batches;
(D) programming code for deleting a search listing from the account record of an advertiser upon receiving a request from said advertiser with the change subsequently made to the listing index in batches;
(E) programming code for modifying the search listing of an advertiser upon receiving a request from said advertiser with any modifications subsequently being made to the listing index in batches;
(F) programming code for generating an activity report for an advertiser upon receiving a request from said advertiser;
(G) programming code for receiving a search request from a remote computer, the search request comprising search terms including at least one keyword and a geographical location, the search request being received over the computer network from the remote-computer through a web site that is publicly accessible without authentication; and
(H) programming code for generating a search result list in response to the search request, the search result list including search listings from a listings index which has been extracted in batches from the account records on the database, wherein the search term for each search listing in the search result list generates a match with the search request, the search listings ordered in the search result list in accordance with the algorithm applied to each search listing.

### BRIEF DESCRIPTION OF THE DRAWINGS

The present invention will be further described with reference to the following non-limiting examples in which;

FIG. 1 is a block diagram illustrating the relationship between a large network and one embodiment of the system and method for generating a pay for-performance search result of the present invention;

FIG. 2 is a diagram of data for an account record for use with one embodiment of the present invention;

FIG. 3 is a flow chart illustrating a method of adding money to an account record used in one embodiment of the present invention;

FIG. 4 is a flow chart illustrating a change bids process used in one embodiment of the present invention; and

FIG. 5 illustrates an example of a screen display used in the change bids process of FIG. 4.

### DETAILED DESCRIPTION

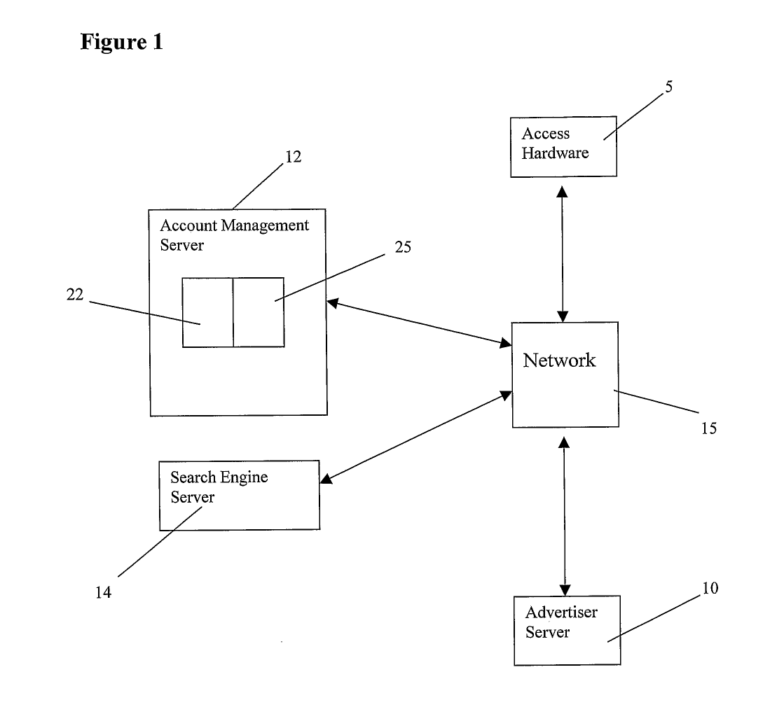

FIG. 1

FIG. 1 is an example of a distributed system of the type that may be used in a preferred embodiment of the present invention. In this system a person desiring access to the system may use a program running on a network to request a service from a server program that is accessible over a communications medium. The server essentially acts as an information provider for the computer network. The communications medium may allow multiple programs to take advantage of the information gathering capabilities of the server. Access may be through a wired service or wireless service.

The distributed system may comprise access hardware 5, advertiser servers 10, an account management server 12, and a search engine server 14, all of which are connected to a network 15 such as, for example, the Internet or a mobile telephone network. The servers may be connected together through any type of wired or wireless network known to the skilled person. Typically the servers include a large number of computers connected by a separate private network.

The access hardware 5 can be, for example, conventional personal computers, mobile telephones, vehicle computers or the like. The access hardware 5 typically includes one or more processors, memories, input/output devices, and a network interface, such as a conventional modem. The access hardware 5 can run web browsers such as Navigator or Explorer to locate web pages or records stored on advertiser server 10. The browsers allow consumers to enter addresses such as URL's of specific web pages to be retrieved. In addition, once a page has been retrieved, the browsers can provide access to other pages or records. For example, when a person uses a personal computer to access the system, this typically occurs when the user “clicks” on hyperlinks to other web pages. The pages can be data records including as content plain textual information, or more complex digitally encoded multimedia content, such as software programs, graphics, audio signals, videos, and so forth.

Typically the account management server 12 includes computer storage medium including a database 25 and a processing system 22. The database 25 contains advertiser account information. Conventional search programs running on client hardware 5 may be used to access advertiser account information stored on account management server 12.

Upon accessing the search engine web server 14 users may type in search terms including one or more keywords and location attributes which the search engine uses to identify relevant pages on the Web and then generate a search result list based on the results of the bidding process conducted by the account management server 12. The search engine web server 14 generates a list of hypertext links to documents that contain information relevant to search terms, including keyword(s) and location attributes, entered by the user into the search engine. The search engine web server 14 transmits this list, in the form of a web page, to the network user, where it is displayed on the browser running on the consumer access hardware 5.

Search engine web server 14 may be connected to the network and may include a search database comprised of search listing records used to generate search results in response to user queries. In addition, search engine web server 14 may also be connected to the account management server 12. The search engine web server 14 and the account management server 12 of the present invention address the different information needs of the users located at client access hardware 5.

For example, the access hardware 5 may be used by network information providers such as advertisers having advertiser web pages located on advertiser web servers 10. These advertisers may wish to access account information residing in storage on account management server 12, for example, to participate in a competitive bidding process. An advertiser may bid on any number of combinations of search terms (such as keywords or business categories) and locations relevant to their business and the goods or services they offer. Typically the relevance of a search term or listing to the corresponding web site is evaluated using a computer program executing at an account management server 12, where the computer program will evaluate the search term and, for example, corresponding goods or services of a business according to a set of predefined editorial rules.

Listings with higher potential yield receive more advantageous placement on the search result list page generated by the search engine 14 when a consumer query matching the advertiser's listing location, category or keyword attributes is executed. An advertiser charge amount is calculated and debited from the account of the advertiser each time the advertiser's web site is accessed via the search result list.

Search result list entries do not typically show the rank value of the advertiser's search listing. The rank value is an ordinal value, preferably a number, generated and assigned to the search listing by the processing system which determines the advertiser's search listing position in the search result listing. The rank value is a comparative measure of the potential economic yield of advertiser search listings. Preferably, the rank value for each advertiser search listing is assigned through a process, implemented in software, that relies upon a mathematical relationship between the bid amount (and/or maximum bid amount), the degree of locality specificity and the search term of a search listing that match the consumer query at this moment. The historic popularity of the listing is an additional preferred parameter which may be used in this process.

The ability to express location as an attribute and therefore affect the rank value is particularly advantageous both to advertisers and consumers. Firstly, it allows advertisers to be able to more effectively target their advertising in the form of Web pages to appropriate groups of consumers. Secondly, it avoids wasting time and money on advertising to consumers who have no interest in the goods or services offered by the advertiser.

Location may be selected from a defined lexicon of national, state regional, and specific suburbs, towns, place names or post codes. A measure of how effectively the location selected by an advertiser meets the location provided by the consumer is used to modify the rank of the advertiser's listing in the search result listing presented to the consumer. This location based “boost factor” is applied against measured popularity (if used) and bid values (including maximum bid amounts) to determine the relative order of the advertiser list presented to the consumer.

The process gathers all search listings that match a consumer's keyword and location specifications and sorts the search listings in order from highest to lowest potential yield derived through assigning a rank value to each search listing. Typically, the listing with the highest potential yield receives the highest rank value, the listing with the next highest potential yield receives the next highest rank value, proceeding to the listing with the lowest potential yield, which receives the lowest rank value. Most preferably, the highest rank value is 1 with successively increasing ordinal values (e.g., 2, 3, 4 . . . ) assigned in order of successively decreasing rank. Preferably, if two search listings match keyword and location attributes and also have the same potential yield, the bid listing that has the higher location boost value (described above) will be assigned the higher rank value.

Each time a user accesses a search listing, the search engine web server 14 will be notified and will associate the access event with the account identifier for the advertiser of that search listing. The account identification information is recorded in the advertiser's account along with information from the retrieval request as a retrieval request event.

In another preferred arrangement, when a remote searcher accesses the search query page on the search engine web server 14 and executes a search request according to the procedure described above, the search engine web server 14 generates and displays a list where the “canonicalized” entry in the search term field of each listing in the list of matching advertisements exactly matches the canonicalized search term entered by the remote searcher and the location field of each business listing in the list of matching advertisements is equivalent to or a parent location of the location entered by the remote searcher.

The canonicalization of search terms used in queries and search listings removes common irregularities of search terms entered by searches and advertisers, such as capital letters and pluralizations, in order to generate relevant results. Alternate schemes for determining a match between the search term field of the search listing and the search term query entered by the remote searcher are employed in the present invention. For example, a thesaurus database of synonyms is stored at search engine web server 24, so that matches are generated for a search term having synonyms. Localization methodologies are also be employed to refine certain searches. For example, a search for “bakery” or “grocery store” is limited to those advertisers who have explicitly defined a location or locations that their business services. This information is not obtained through a cross-reference of the advertiser account database stored at storage 32 on account management server 22.

Alternatively, string matching algorithms known in the art may be employed to generate matches where the keywords of the search listing and the keyword query have the same root but are not exactly the same (e.g., computing vs. computer). Finally, internationalization methodologies may be employed to refine searches for users from different countries. For example, country or language-specific search results may be generated, by a cross-reference of the advertiser account database.

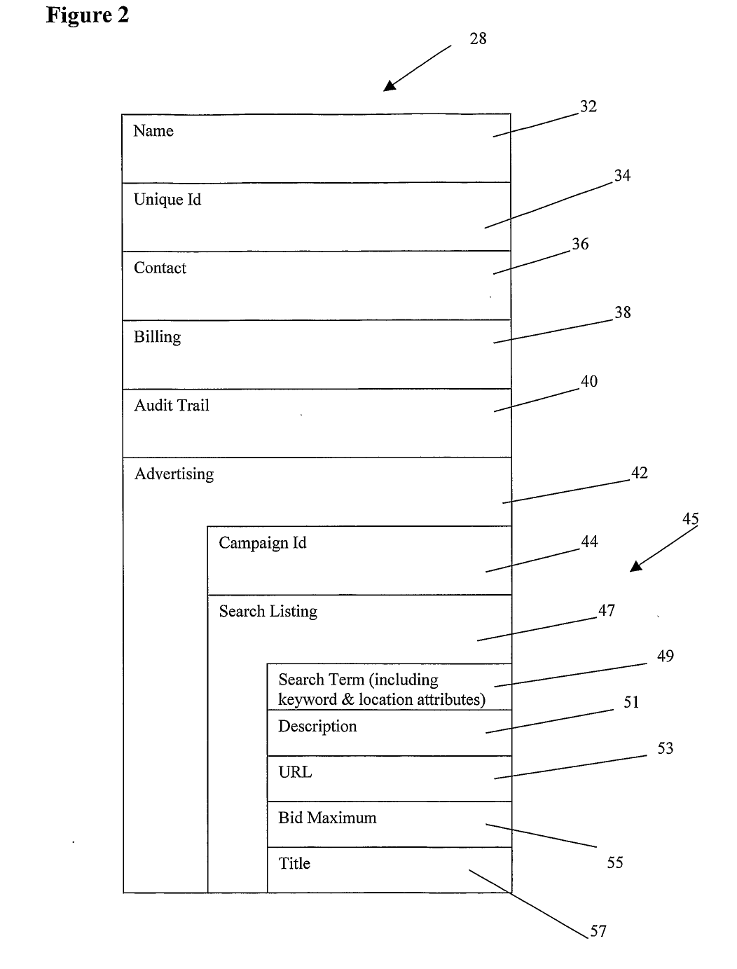

FIG. 2

FIG. 2 illustrates the types of information contained in each advertiser account record 28. The information includes a username 32; a password 34 used for online authentication; other information 36 such as street address, phone, e-mail address; billing information 38 such as account balance, credit card information, monthly spend cap; audit trail list 40; and advertising information.

The billing information 38 contains data accessed when the advertiser selects the option to clear the debt against the advertiser's account. The monthly cap value is used to automatically limit the amount of credit extended to an advertiser within the system in any given month. In addition, certain billing information, such as the current balance in conjunction with monthly cap, may trigger events requiring notification, suspension or credit collection actions and alerts.

The audit trail list 40 contains a record of all events wherein the account record 28 is accessed.

The advertising information section 42 contains information needed to conduct the match and presentation process of the present invention, wherein selection and rank is determined for a business listing within a search result list generated by a search engine. The advertising data 42 for each user account 28 may be organized as zero or more campaigns 45. Each campaign 45 comprises a campaign number 44 and at least one search listing 47. Each search listing corresponds to at least one set of search terms including locations. An advertiser may utilize campaigns to organize multiple bids on multiple search terms or locations, or to organize bids for multiple web sites, phone numbers or physical addresses. Campaigns are also particularly useful for advertisers seeking to track the performance of targeted market segments. The campaign superstructure is introduced for the benefit of the advertisers seeking to organize their advertising efforts, and does not affect the method of operation of the present invention. Alternatively, the advertising information section need not include the added organizational layer of campaigns, but may simply comprise one or more search listings.

Several choices are presented to the advertiser to manage their campaigns. First, the advertiser may change the advertiser bid amount for search listings currently in the account. The change to the advertiser bid amount does not immediately invoke any process in the system. After the advertiser indicates the intent to change the bid amount, the system searches the advertiser account in the database and displays the search listings for the entire account or a campaign in the advertiser account. Search listings may be grouped into campaigns defined by the advertiser and may comprise one or more business listings. Only one campaign may be displayed at a time. The display should also preferably permit the advertiser to change the campaign selected. The screen display will then show the search listings for the selected campaign.

The search listing 47 corresponds to a search term contains key information to conduct the online ranking and pricing process. Preferably, each search listing comprises the following information: search term 49, description of goods or services (for text or voice) 51, URL, phone number, SMS address or other address to facilitate customer referrals 53, maximum bid amount 55, and a title 57. The search term 49 contains discrete fields for keyword (or category attributes) and location attributes. That is, location attributes are assigned to the listing, and keywords and optionally, categories are also assigned to the listing, however location attributes are not assigned to keywords or categories.

Keywords may be common words in English (or any other language). Categories may be defined by the system and selected by the advertiser. Both keywords and categories comprise a character string. Keywords and categories are the objects of the competitive online bidding process which is enacted upon a receipt of a consumer's query. The advertiser selects a keyword or category that is relevant to the content of the advertiser's web site. Ideally, the advertiser may select a search term that is targeted to terms likely to be entered by searchers seeking the information on the advertiser's web site, although less common search terms may also be selected to ensure comprehensive coverage of relevant search terms for bidding. In addition categories are selected. Categories are selected to provide coverage where specific keywords are not utilized such as voice operated concierge services. The advertiser search listing is targeted against a set of predefined business headings and a heading is selected by the voice concierge service operator.

The business description 51 is a short textual description of the products and services offered by the advertiser. This description 51 may be displayed as part of the advertiser's entry in a search result list, read to a consumer by an operator or sent to a consumer's wireless device via an SMS message. The search listing 47 may also contain a title for the search listing that may be displayed as the hyperlinked heading to the advertiser's entry in a search result list, read out as the essential business offering over the phone, or sent by SMS to a consumer. The address 53 contains the URL of the advertiser's web site, the advertiser's phone number and/or the physical address of the advertiser's point of business. For example, a URL is provided to the browser program. The browser program, in turn, accesses the advertiser's web site through the redirection mechanism discussed above. The URL may also be displayed as part of the advertiser's entry in a search result list. Alternatively, the concierge operator selects the listing, a referral is logged by the system and the consumer is connected to the advertiser's designated phone line and/or receives the phone number by SMS. Thirdly, a listing may be selected via an in-car navigation or other mobile device such as a mobile phone and, after the referral is logged in the system, the device is sent a map or turn by turn directions to the advertiser's business location.

The advertiser bid amount 55 preferably is a specified money amount or specified range amount of money bid by an advertiser to be associated with its listing. The money amount or the upper limit of the range is set as the maximum amount that an advertiser will pay for a referral against the parameters defined for the listing. However, each time an advertiser is matched against a consumer query, the minimum amount required to achieve the optimal rank within the set of matching advertisers (the advertiser charge amount) is calculated and logged. Later, all referrals for the previous cycle are summed and recorded. At the end of each month, the debit balance is either recovered from a credit card or invoiced. A rank value and subsequent advertiser charge cost is only ever calculated in response to a search query, as this is the first time the system will identify the matching advertiser search listings.

Once logged in, an advertiser can perform a number of straightforward tasks, including viewing a list of rules and policies for advertisers, changing contact information and billing information, updating access profile, adding or deleting listings, search terms or locations, changing a maximum bid amount and requesting customer service assistance, and viewing transaction histories. These items cause routines to be invoked to implement the request.

In addition, the advertiser may set notification options. The advertiser may select options that will cause the system to notify the advertiser when certain key events have occurred. For example, the advertiser may elect to set an option to have the system send conventional electronic mail messages to the advertiser when the advertiser's account balance has reached a specified level. In this manner, the advertiser may receive a “warning” to reset the monthly cap or make a payment before the account is suspended (meaning the advertiser's listings will no longer appear in search result lists). Another key event for which the advertiser may wish to receive notification is a rejected credit card account payment. To this end, at the end of the month the system will attempt to charge the advertiser's credit card for the amount owing on the advertiser's account. If payment fails, the account is suspended and a notification is sent to the advertiser. When one of the system specified key events occurs, a database search is triggered for each affected search listing. The system will then execute the appropriate notification routine in accordance with the notification options specified in the advertiser's account.

Advertisers meeting selected business criteria may elect, in place of having their monthly account charged to a credit card, to incur account charges regardless of account balance and pay an invoiced amount at regular intervals which reflects the charges incurred by actual referrals to the advertiser's business generated by the system.

In an alternate embodiment of the present invention, advertisers may settle their account by transferring the desired amount from the advertiser's bank account through an electronic funds verification mechanism known in the art such as direct debit or BPay. In another alternate embodiment of the present invention, advertisers can settle their account using conventional paper-based cheques. In that case, the additional funds may be updated in the account record database through manual entries.

An instrument information field may be provided which includes further details regarding the type of payment. For example, for a credit card, the instrument information may include data on the name of the credit card (e.g., MasterCard, Visa, or American Express), the credit card number, the expiration date of the credit card, and billing information for the credit card (e.g., billing name and address). In a preferred embodiment of the present invention, only a partial credit card number is displayed to the advertiser for security purposes.

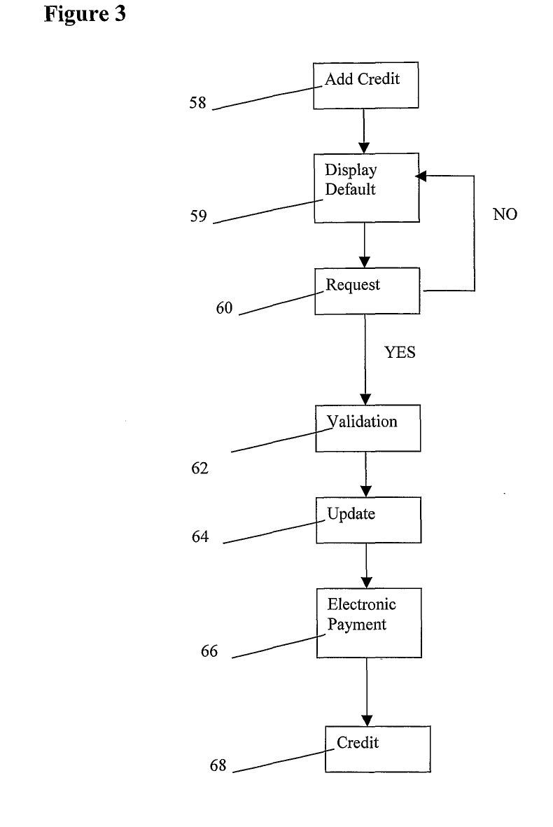

FIG. 3

FIG. 3 is a flow chart illustrating a method of adding money to an account record used in one embodiment of the present invention.

An advertiser can choose an option 58 to add money to their account. The default values displayed 59 to the advertiser are obtained from a persistent state, e.g., stored in the transaction gateway provider's database. The default billing information is displayed to the advertiser in a web-based form. The advertiser may click on the appropriate text entry boxes on the web based form and make changes to the default billing information. After the advertiser completes the changes, the advertiser may request that the system update the billing information in step 60, or alternatively return to the default value display 59. When an advertiser has requested an update to the default billing details, a function is invoked by the system which validates the billing information provided by the advertiser and displays it back to the advertiser for confirmation, as shown in step 62. The confirmation billing information is displayed in read-only form and may not be changed by the advertiser.

The validation step functions as follows. If payment is to be debited from an advertiser's external account, payment may be authenticated, authorized and completed. However, if the payment type is by credit card, a validating algorithm is invoked by the system, which validates the credit card number. In addition, the function stores the new values in a temporary instance prior to confirmation by the advertiser.

Once the advertiser ascertains that the displayed data is correct, the advertiser may be required to confirm their data is correct to indicate that the account should be updated in step 64. In step 64, a function is invoked by the system which adds money to the appropriate account balance, updates the advertiser's billing information, and appends the billing information to the advertiser's payment history. The advertiser's updated billing information is stored payment gateway provider.

Within the function invoked at step 64, an electronic payment function may be invoked by the system at step 66. In an alternate embodiment of the present invention, other payment functions such as debit card payments may be invoked by defining multiple payment types depending on the updated value of the payment type.

If the payment type is credit card, the user's account is credited immediately at step 68, the user's credit card having already been validated in step 62. A screen showing the status of the add money transaction is displayed, showing a transaction number and a new current balance, reflecting the amount added by the just-completed credit card transaction.

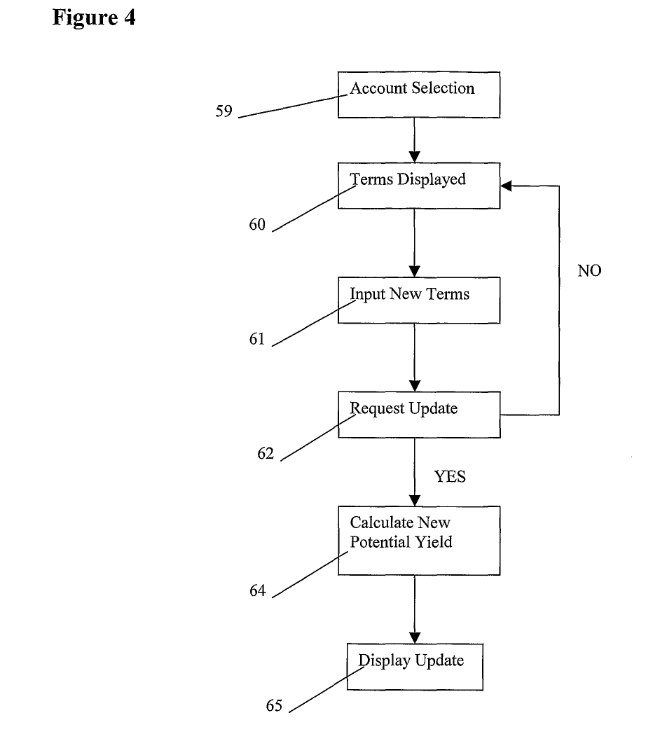

FIG. 4

FIG. 4 is a flow chart illustrating a change bids process used in one embodiment of the present invention.

To change bids, the advertiser user may specify new bids for search terms and locations for which the advertiser already has an existing bid by choosing the relevant account 59, by entering a new bid amount into the new bid input field for the search tem or location. The advertiser-entered bid changes are displayed to the advertiser at step 60. To update the bids for the display page, the advertiser inputs the new terms 61 then requests, at step 62, that the terms be updated. The advertiser may transmit such a request to the account management server by a variety of means, including clicking on a button graphic.

As shown in step 64, upon receiving the request to update the advertiser's bids, the system calculates the new current potential yields without the impact of any locality boost for every business listing that matches the keyword component of the advertiser's listing, and the maximum bid amount needed to become the highest ranked search listing for the search terms and locations. The updated terms are then displayed 65.

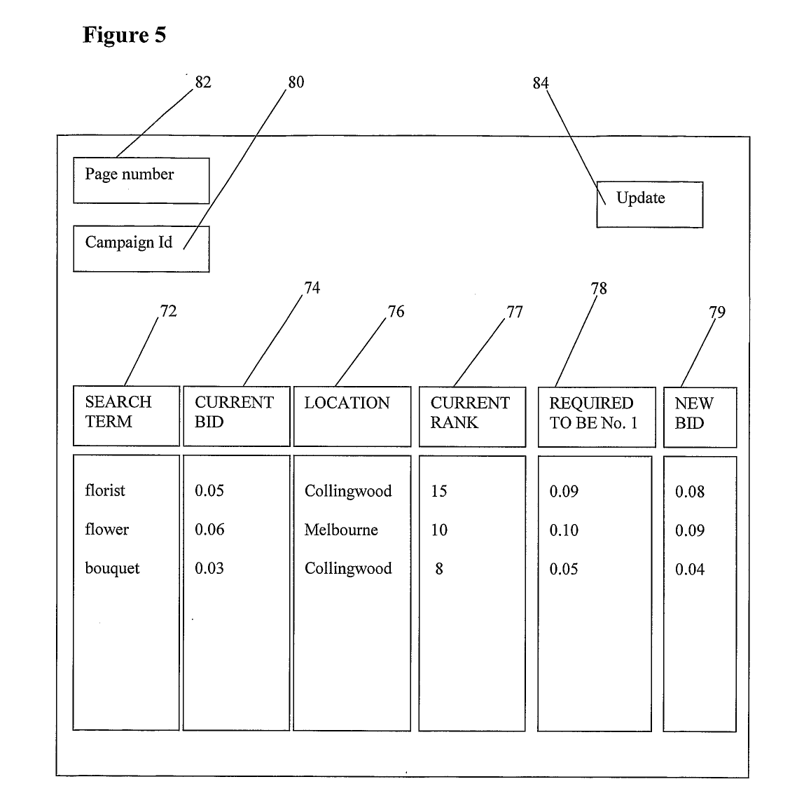

FIG. 5

The search listing data is displayed in tabular format, with each search listing corresponding to one row of the table 70. The search term 72 is displayed in the leftmost column, followed by the current bid amount 74, the location settings 76, and the this month's average rank 77 of the search listing. This month's average rank is followed by a column entitled “Required to be No. 1” 78, defined as the estimated maximum bid amount needed to become the highest ranked search listing for the displayed keyword and location configuration. The rightmost column of each row comprises a new bid input field 79 which is set initially to the current bid amount.

The search listings may be displayed as “campaigns.” Each campaign comprises one search listing group, with multiple campaigns residing within one advertiser account. Each campaign may be displayed on a separate display page having a separate page. The advertiser should preferably be able to change the campaign being displayed by manipulating a pull-down menu 80 on the display shown in

FIG. 5. In addition; business listing groups that cannot be displayed completely in one page may be separated into pages which may be individually viewed by manipulating pull-down menu 82. Again, the advertiser should preferably be able to change the page displayed by clicking directly on a pull-down menu 82 located on the display page of FIG. 5. The advertiser may specify a new bid for a displayed search listing by entering a new bid amount into the new bid input field 79 for the business listing. To update the result of the advertiser-entered changes, the advertiser clicks on button graphic 84 to transmit an update request to the account management server, which updates the bids as described above.

The word ‘comprising’ and forms of the word ‘comprising’ as used in this description and in the claims does not limit the invention claimed to exclude any variants or additions.

1. A method of generating a search result list in response to a search request from a searcher, comprising:
(a) maintaining a database of search listings each associated with an advertiser, wherein each search listing is associated with;
(i) a network location or other contact information;
(ii) at least one search term; and
(iii) an advertiser bid amount that is modifiable according to a comparison between a geographical location specified by a searcher and geographical location attributes specified by the advertiser;
(b) receiving a search request from the searcher;
(c) identifying the search listings having search terms generating a match with the search request;
(d) ordering the identified search listings into a search result list in accordance with an algorithm applied to each search listing which algorithm includes a location variable component having a value that depends upon the geographical location attributes specified by the advertiser compared to a location specified by the searcher;
(e) receiving a request from the searcher to retrieve information associated with a search listing in the search result list generated at step (d); and
(f) recording the retrieval request event including account identification information corresponding to the advertiser and calculating an advertiser charge amount based upon the advertiser bid amount, to permit maintenance of accurate advertiser account records.

2. The method of claim 1 wherein the algorithm applied to each search listing generates a potential yield for each of the identified search listings and the identified search listings are ordered into a search results list in accordance with the values of the potential yields.

3. The method of claim 1 wherein the advertiser bid amount may be a single value or a range of values.

4. A system for carrying out the method of claim 1 using a computer system comprising a database with at least one account record for each of a plurality of advertisers, the account record including:
(a) at least one search listing including;
(i) a network location or other contact information;
(ii) at least one search term; and
(iii) an advertiser bid amount that is modifiable according to a comparison between a geographical location specified by a searcher and geographical location attributes specified by the advertiser;
(b) an account balance;
(c) a history of search listings;
(d) payment processing information, wherein said payment processing information is accessible to the computer system and isolated from public access via the computer network; and
(e) a payment history.

5. A system according to claim 4 which comprises,
(A) programming code for providing the advertiser with login access in response to authentication, wherein the advertiser's login access grants the advertiser access to modify the advertiser account record, the advertiser not being provided with access to modify the accounts of others;
(B) programming code for adding money to increase the account balance of an advertiser upon receiving a request from said advertiser;
(C) programming code for adding a search listing to an advertiser account record upon receiving a request from said advertiser and subsequently exporting the search listing to the listing index in batches;
(D) programming code for deleting a search listing from the account record of an advertiser upon receiving a request from said advertiser with the change subsequently made to the listing index in batches;
(E) programming code for modifying the search listing of an advertiser upon receiving a request from said advertiser with any modifications subsequently being made to the listing index in batches;
(F) programming code for generating an activity report for an advertiser upon receiving a request from said advertiser;
(G) programming code for receiving a search request from a remote computer, the search request comprising search terms including at least one keyword and a geographical location, the search request being received over the computer network from the remote-computer through a web site that is publicly accessible without authentication; and
(H) programming code for generating a search result list in response to the search request, the search result list including search listings from a listings index which has been extracted in batches from the account records on the database, wherein the search term for each search listing in the search result list generates a match with the search request, the search listings ordered in the search result list in accordance with the algorithm applied to each search listing.

6. A method of enabling an advertiser to update information relating to a search listing on a search result list generated by a computer network search engine, comprising the steps of:
(A) maintaining an account database having at least one account record for each of a plurality of advertisers, the account record including:
(a) at least one search listing including;
(i) a network location or other contact information;
(ii) at least one search term; and
(iii) an advertiser bid amount that is modifiable according to a comparison between a geographical location specified by a searcher and geographical location attributes specified by the advertiser;
(b) an account balance;
(c) a history of search listings;
(d) payment processing information, wherein said payment processing information is accessible to the computer system and isolated from public access via the computer network; and
(e) a payment history;
(B) receiving from an advertiser a change request for a search listing in the advertiser account record;
(C) updating the search listing in the advertiser account record in response to the change request; and
(D) determining a position for the updated search listing in a search result list generated by the search engine in response to a search request received from a searcher using the computer network;
(E) calculating the position of the updated search listing in the search result list using an algorithm applied to each search listing which algorithm includes a location variable component having a value that depends upon the geographical location attributes specified by the advertiser compared to a location specified by the searcher.

7. The method according to claim 6, further comprising the steps of:
(F) determining a creation time value for each search listing in the account database;
(G) identifying search listings within a search result list having equivalent potential yield amounts; and
(H) for a group of search listings within a search result list that have equivalent potential yield amounts, sorting the search listings in order of highest location boost first.

8. The method of claim 6 wherein the algorithm applied to each search listing generates a potential yield for each of the identified search listings and the identified search listings are ordered into a search results list in accordance with the values of the potential yields at the time the search query is received.

9. The method of claim 6 wherein the advertiser bid amount may comprise a single value or a range of values.

10. A method of enabling an advertiser to update information relating to a search listing on a search result list generated by a computer network search engine substantially in real time in response to a search request received from a remote computer over the computer network, comprising the steps of:
(A) maintaining an account database having at least one account record for each of a plurality of advertisers, the account record including:
(a) at least one search listing including;
(i) a network location or other contact information;
(ii) at least one search term; and
(iii) an advertiser bid amount that is modifiable according to a comparison between a geographical location specified by a searcher and geographical location attributes specified by the advertiser;
(b) an account identifier; and
(c) other search listings against which is set the rank of the aforesaid search listing;
(B) providing the advertiser with authenticated login access, wherein the advertiser's login access permits the advertiser to modify their account record;
(C) modifying a search listing of the account record upon receiving a request from said advertiser; and
(D) generating a search result list comprised of search listings wherein the search term and geographical location attributes for each search listing are matched to the search request, the search listings in the search result list being ordered in accordance with an algorithm applied to each search listing which algorithm includes a location variable component having a value to that depends upon the geographical location attributes specified by the advertiser compared to a location specified by the searcher.

11. The method of claim 10, wherein the step of modifying the search listing of the advertiser account record upon receiving a request from the advertiser is facilitated by periodic batch exports to the database.

12. The method of claim 10, wherein an advertiser charge amount comprises a money amount calculated based upon the advertiser bid amount, the advertiser charge amount being calculated each time the search listing is selected by a remote searcher and subsequently deducted from the advertiser account balance.

13. The method of claim 12 wherein the advertiser bid amount may be a single value or a range of values.

14. A method of enabling an advertiser to update information relating to a search listing on a search result list generated by a computer network search engine in response to a search request received from a remote computer over the computer network, comprising the steps of:
(A) maintaining an account database having at least one account record for each of a plurality of advertisers, the account record including:
(a) at least one search listing including;
(i) a network location or other contact information;
(ii) at least one search term; and
(iii) an advertiser bid amount that is modifiable according to a comparison between a geographical location specified by a searcher and geographical location attributes specified by the advertiser;
(b) an account identifier;
(b1) an account balance;
(b2) payment processing information for the advertiser, said payment processing information maintained isolated from public access via the computer network;
(b3) a payment history;
(b4) a history of search listings; and
(c) other search listings against which is set the rank of the search listing;
(B) providing the advertiser with authenticated login access, wherein the advertiser's login access permits the advertiser to modify their account record;
(C) modifying a search listing of the account record upon receiving a request from said advertiser and later exporting that listing to a listing index for searching;
(D) receiving a search request, the search request including at least one keyword, and a location the search request being received over the Internet from a searcher at a remote computer; and
(E) generating a search result list comprised of search listings wherein the search term and geographical location attributes for each search are matched to the search request, the search listings in the search result list being ordered in accordance with an algorithm applied to each search listing which algorithm includes a location variable component having a value that depends upon the geographical location attributes specified by the advertiser compared to a location specified by the searcher.
